(19) United States
(12) Patent Application Publication
(10) Pub. No.: US 2010/0158244 A1
(43) Pub. Date: Jun. 24, 2010

(54) COMMUNICATION ENCRYPTION METHOD FOR SUPPORTING REMOTE MONITORING AND CONTROL SYSTEM

(75) Inventors: Zhen-Bao Sun, Tianjin (CN); Ping Song, Tianjin (CN); Tom Chen, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/342,723

(22) Filed: Dec. 23, 2008

(51) Int. Cl. H04L 9/00; G06F 15/16

(52) U.S. Cl. 380/37; 726/15

(57) ABSTRACT

A communication encryption method for supporting a remote monitoring and control system includes establishing a communication network between a server and a remote host, encrypting a data to be transmitted/received, and testing terminal equipment connected to the remote host. The method includes the steps. The server sequentially partitions a test data, and performs a compression program and an encryption program to produce a plurality of first partitioned data, a compressed data, and a plurality of encrypted data respectively; next, the server transmits the encrypted data to the remote host; the remote host performs a decryption program sequentially to restore the encrypted data into the second partitioned data, then combines the second partitioned data into the compressed data, and performs a decompression program on the compressed data to restore the data into the first partitioned data, then recombines the first partitioned data to restore the data into the test data.

### BACKGROUND OF THE INVENTION

1. Field of the Invention

The present invention relates to a communication method, and more particularly to a communication encryption method for supporting a remote monitoring and control system, in which a communication network is established between a server and a remote host, data to be transmitted/received is encrypted, and terminal equipment connected to the remote host is tested.

2. Related Art

With the rapid development of electronic products, in order to alleviate the manufacturing and testing burdens, most upstream manufacturers distribute their testing work to downstream manufacturers. Unfortunately, the manufacturers are not located quite close to each other, so that the manufacturers use the Internet to perform tests through remote control, so as to reduce the time required for forwarding the test data. FIG. 1 is a schematic view of the prior art. Referring to FIG. 1, the testing method of the prior art includes the following steps. First, a server of the upstream manufacturer provides a test data to a remote host of the downstream manufacturer (Step S110). After receiving the test data, the remote host tests the terminal equipment based on the test data (Step S120). After completing the test program, the remote host returns a test result to the server (Step S130).

Besides preventing the test program from being monitored by a third party, the downstream manufacturer is further required to guarantee the confidentiality of the intellectual property rights of the upstream manufacturer. In other words, the data transmitted and the results received by the upstream manufacturer must be processed by a specific encryption manner, so as to prevent some important test data from being intercepted by others.

### SUMMARY OF THE INVENTION

In view of the above problems, the present invention is mainly directed to a communication encryption method for supporting a remote monitoring and control system, which includes establishing a communication network between a server and a remote host, and transmitting a test data to the remote host to test the terminal equipment connected to the remote host.

In order to achieve the above objective, the present invention provides a communication encryption method for supporting a remote monitoring and control system, which includes the following steps: partitioning a test data by the server to produce a plurality of first partition data; performing a compression program on the first partitioned data sequentially, and combining the obtained results to produce a compressed data; partitioning the compressed data to produce a plurality of second partitioned data; performing an encryption program on the second partitioned data to produce a plurality of encrypted data; transmitting the encrypted data to the remote host; performing a decryption program by the remote host to restore the encrypted data into the second partitioned data; performing a decompression program on the second partitioned data to restore the data into the compressed data; performing the decompression program on the compressed data to restore the data into the first partitioned data; restoring the first partitioned data into the test data; and sending the test data to the terminal equipment for testing the terminal equipment.

Before the server provides the test data to the remote host, the server compresses and encrypts the test data. Then, the server transmits the encrypted data to the remote host through the communication network. Then, the remote host performs a restoring process on the received encrypted data to retrieve the test data. Finally, the remote host performs a test program on the terminal equipment based on the test data.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the prior art;

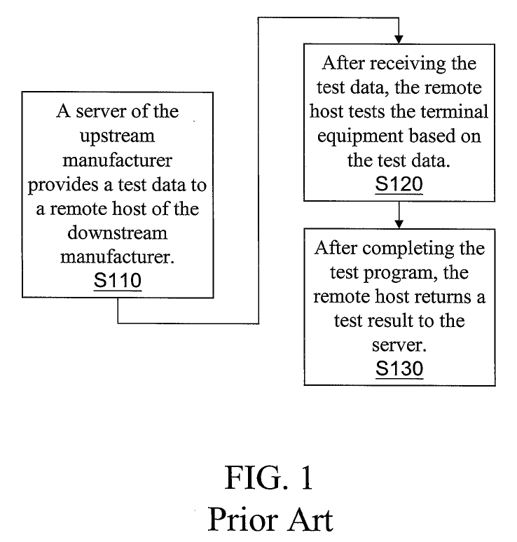

FIG. 2 is a schematic view of an architecture of the present invention;

FIG. 3 is a schematic view of an operation flow of the present invention;

FIG. 4A shows a transmission architecture of an implementing aspect of the present invention;

FIG. 4B is a schematic view of producing a plurality of first partitioned data;

FIG. 4C is a schematic view of producing a compressed data;

FIG. 4D is a schematic view of producing a plurality of second partitioned data;

FIG. 4E is a schematic view of a format of the second partitioned data with the first information and the second information added;

FIG. 4F is a schematic view of producing a plurality of encrypted data;

FIG. 4G is a schematic view of restoring into the second partitioned data;

FIG. 4H is a schematic view of restoring into the compressed data;

FIG. 4I is a schematic view of restoring into the first partitioned data; and

FIG. 4J is a schematic view of restoring into the test data.

### DETAILED DESCRIPTION OF THE INVENTION

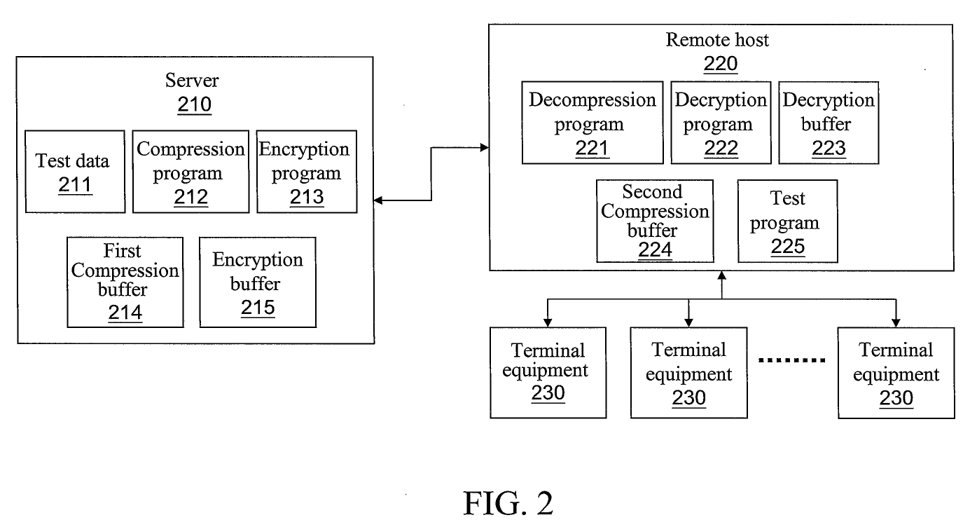

FIG. 2 is a schematic view of an architecture of the present invention. Referring FIG. 2, the architecture of the present invention includes a server 210, a remote host 220, and terminal equipment 230. The server 210 stores a test data 211, a compression program 212, an encryption program 213, a first compression buffer 214, and an encryption buffer 215. A communication network is established between the server 210 and the remote host 220 for transmitting the test data 211 there-between. The communication network may be a virtual private network (VPN) or a secure tunnel network architecture. The remote host 220 stores a decompression program 212, a decryption program 222, a decryption buffer 223, a second compression buffer 224, and a test program 225. The remote host 220 is electrically connected to the terminal equipment 230, in which the terminal equipment 230 may be a chip, a peripheral interface card, a peripheral device, and the like.

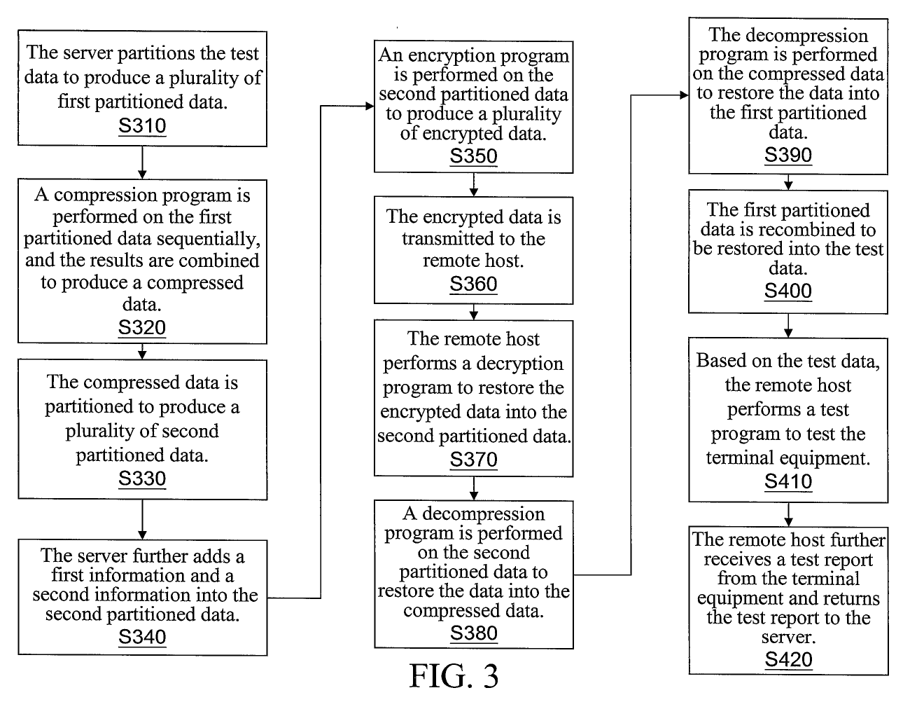

FIG. 3 is a schematic view of an operation flow of the present invention. Referring FIG. 3, the communication method of the present invention includes the following step. The server partitions the test data to produce a plurality of first partitioned data (Step S310), in which the test data 211 is partitioned with an equal capacity based on a length of a first fixed data capacity, so as to produce the first partitioned data. Next, a compression program is performed on the first partitioned data sequentially, and the results are combined to produce a compressed data (Step S320), and the compressed data is stored in the first compression buffer 214. Then, the compressed data is partitioned to produce a plurality of second partitioned data (S330), in which the compressed data is partitioned with an equal capacity based on the length of the first fixed data capacity, so as to produce the second partitioned data. Then, the server further adds a first information and a second information into the second partitioned data (S340), in which the first information is used to indicate such a second partitioned data has been encrypted, and the second information is used to record a valid length of the compressed data. Then, an encryption program is performed on the second partitioned data to produce a plurality of encrypted data (Step S350). Then, the plurality of encrypted data is stored in the encryption buffer 215.

The encrypted data is transmitted to the remote host (Step S360), and the encrypted data is stored in the decryption buffer 223. The remote host performs a decryption program to restore the encrypted data into the second partitioned data (Step S370). It should be noted that, each time when a data capacity of the encrypted data reaches a second fixed data capacity, the decryption program 222 is performed on the encrypted data to obtain the second partitioned data.

Then, a decompression program is performed on the second partitioned data to restore the data into the compressed data (Step S380). Then, the decompression program is performed on the compressed data to restore the data into the first partitioned data (Step S390). Particularly, when a capacity of the data output by the decompression program 212 reaches the first fixed data capacity, the data is stored as the first partitioned data. Then, the first partitioned data is recombined to be restored into the test data (Step S400). Based on the test data, the remote host performs a test program to test the terminal equipment (Step S410). The remote host further receives a test report from the terminal equipment and returns the test report to the server (Step S420).

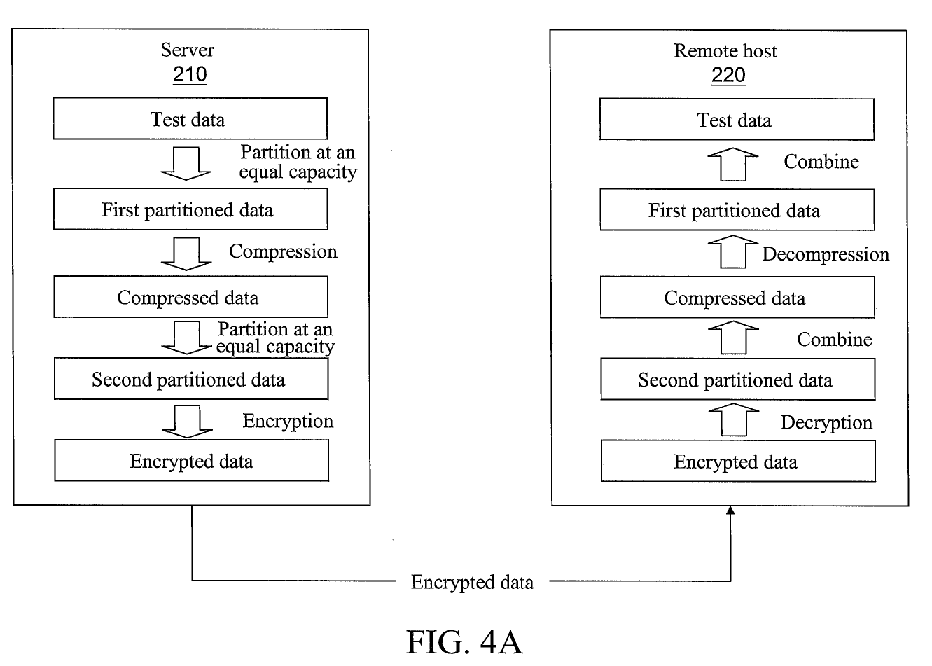

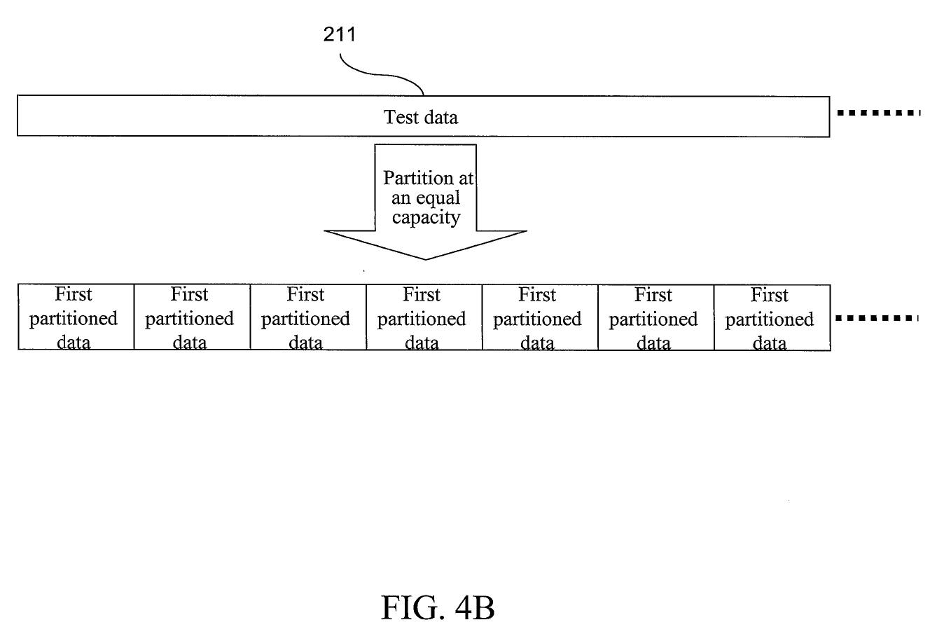

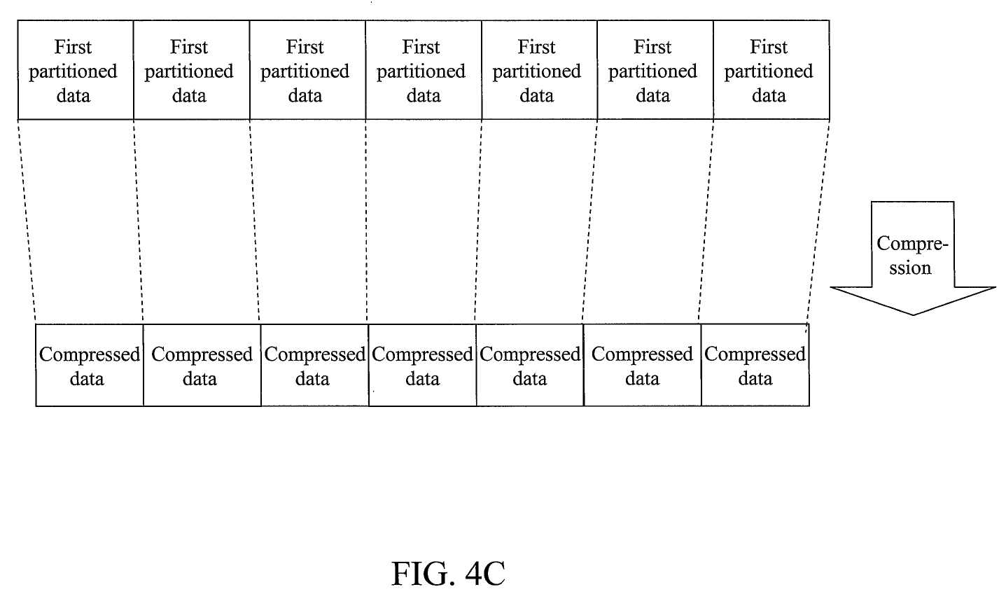

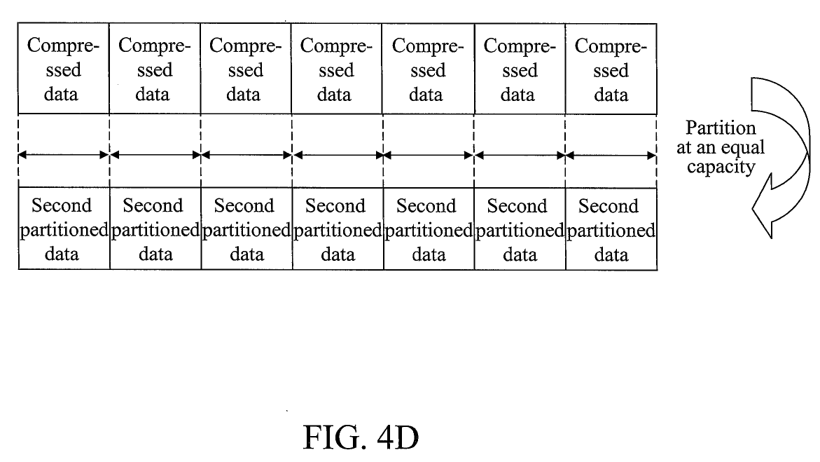

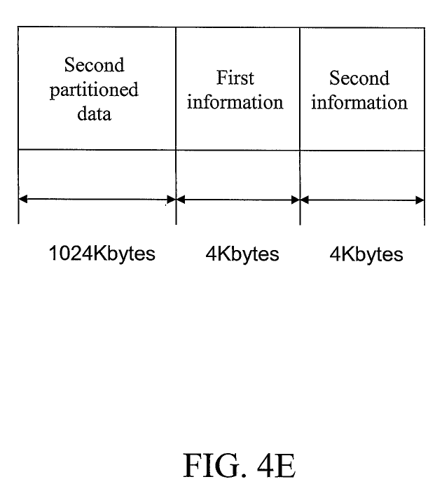

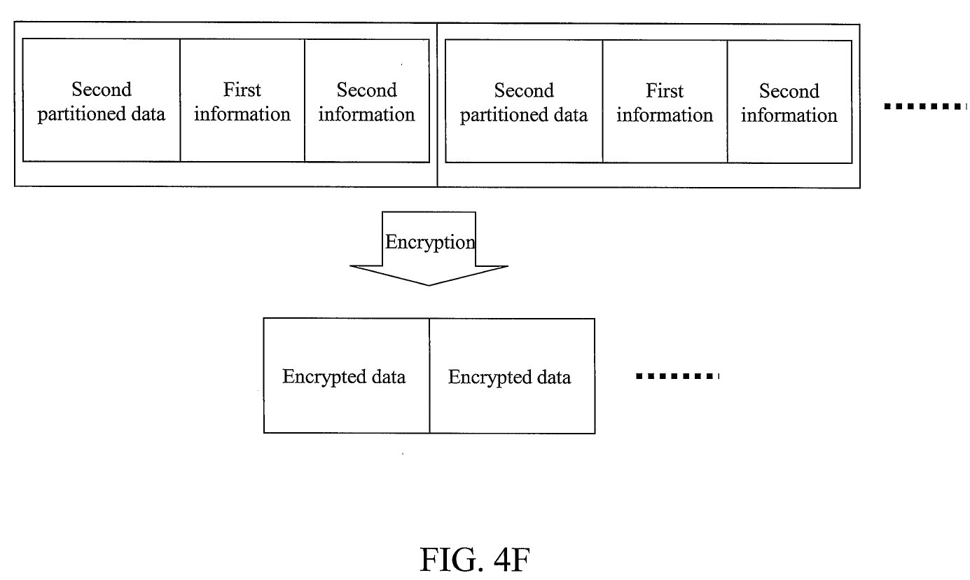

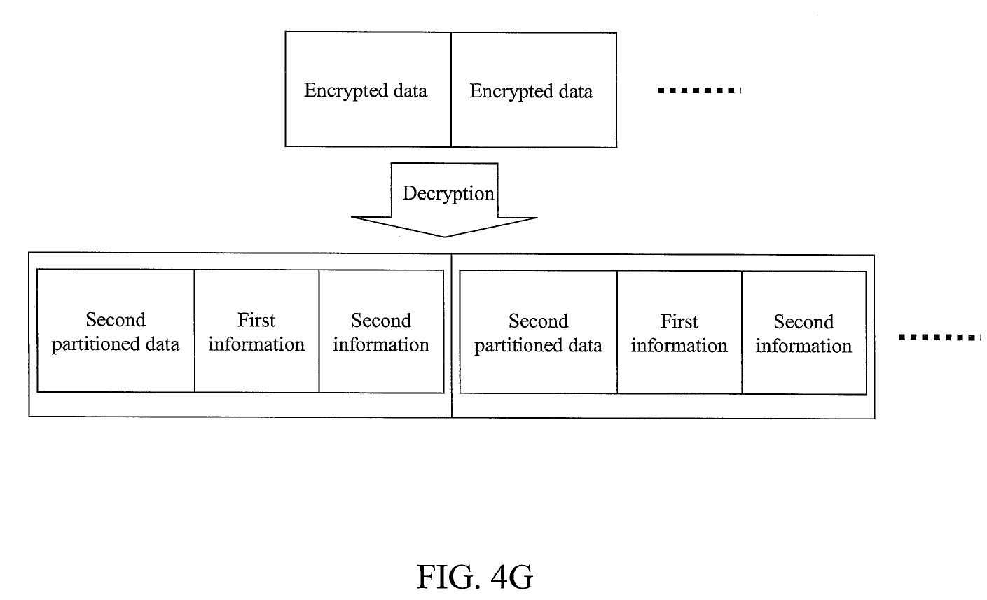

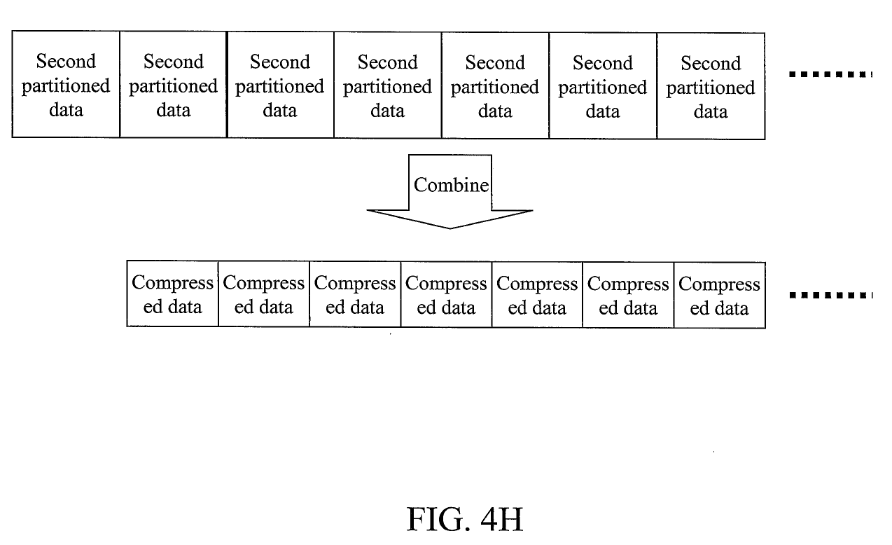

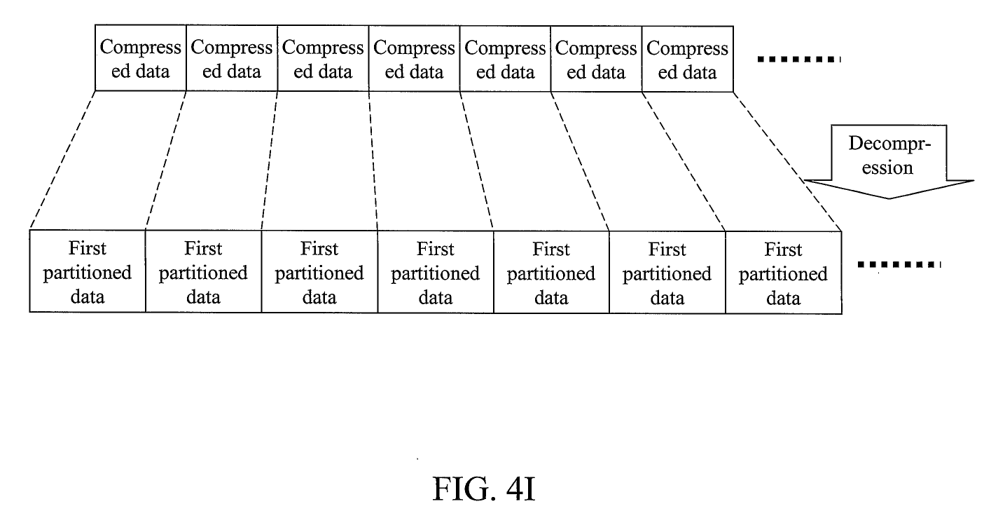

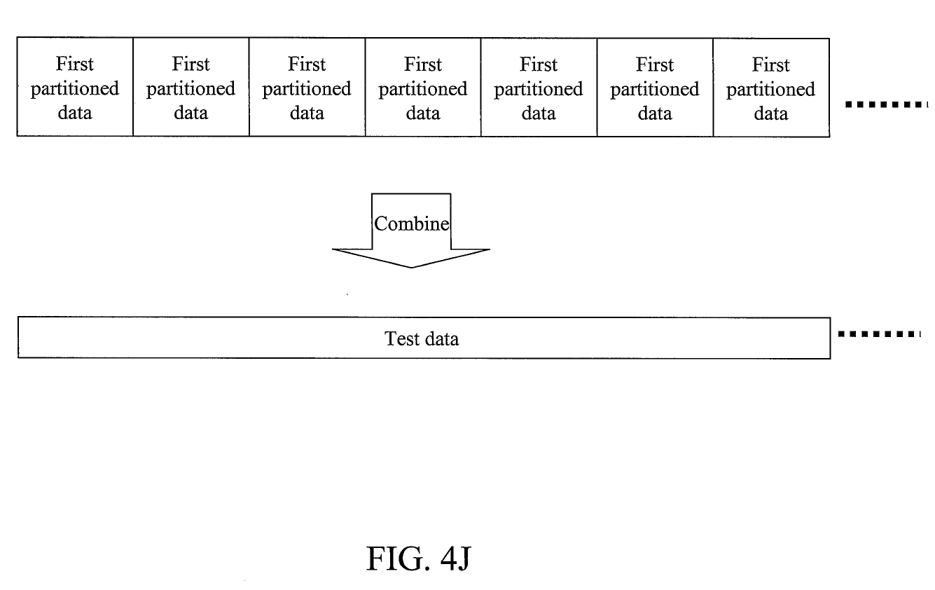

In order to clearly describe the operation process of the present invention, it is further demonstrated below, in which the parameters are not limited herein. FIG. 4A shows a transmission architecture of an implementing aspect of the present invention. Referring FIG. 4A, the server 210 is shown on the left of FIG. 4A, and the remote host 220 is shown on the right.

The server 210 partitions the test data 211 with an equal capacity based on a length of the first fixed data capacity, so as to produce a plurality of first partitioned data. It is assumed that the first fixed data capacity is 1024 Kbytes, so that the server 210 partitions the test data 211 to produce a plurality of the first partitioned data with a capacity of 1024 Kbytes. Referring to FIG. 4B, it is a schematic view of producing a plurality of first partitioned data. The server 210 performs the compression program 212 on each of the first partitioned data, combines the output results into the compressed data, and stores the compressed data in the first compression buffer 214. Referring to FIG. 4C, it is a schematic view of producing a compressed data.

Once the capacity of the compressed data in the first compression buffer 214 reaches the first fixed data capacity, the server 210 partitions the compressed data into the second partitioned data segment by segment, and stores the second partitioned data in the encryption buffer 215. Referring to FIG. 4D, it is a schematic view of producing a plurality of second partitioned data. It should be particularly noted that, the server 210 adds a first information and a second information into the second partitioned data. It is assumed herein that a length of the first information is 4 Kbytes, and a length of the second information is 4 Kbytes. Referring to FIG. 4E, it is a schematic view of a format of the second partitioned data with the first information and the second information added. When the capacity of the second partitioned data in the encryption buffer 215 reaches the first fixed data capacity, the server 210 performs the encryption program 213 on the second partitioned data to produce the encrypted data. Referring to FIG. 4F, it is a schematic view of producing a plurality of encrypted data.

Then, the server 210 transmits the encrypted data to the remote host 220. The remote host 220 stores the encrypted data to the decryption buffer 223. Each time when the capacity of the encrypted data reaches the second fixed data capacity, the remote host 220 performs the decryption program 222 on the encrypted data and restores the data into the second partitioned data. Since the encrypted data is added with the first information and the second information, the second fixed data capacity is set as 1032 Kbytes. Referring to FIG. 4G, it is a schematic view of restoring into the second partitioned data.

The remote host 220 combines the second partitioned data sequentially and restores them into the compressed data. Referring to FIG. 4H, it is a schematic view of restoring into the compressed data. Then, the decompression program 212 is performed on the compressed data. It should be particularly noted that, each time when a capacity of the data output by the decompression program 212 reaches the first fixed data capacity, it is stored to the second compression buffer 224 as a first partitioned data. Referring to FIG. 4I, it is a schematic view of restoring into the first partitioned data. After the first partitioned data is processed by the compression program 212, the data capacities of the resulted compressed data are not the same. However, the data capacities of the first partitioned data are all 1024 Kbytes. In other words, each time when the capacity of the data output by the decompression program reaches the first fixed data capacity, one first partitioned data is completed. Then, the remote host 220 recombines the first partitioned data sequentially to restore them into the test data 211. Referring to FIG. 4J, it is a schematic view of restoring into the test data.

After the remote host 220 has finished the restoring process of the encrypted data, the remote host 220 performs the test program 225 based on the test data 211. The remote host 220 begins to test the terminal equipment 230 connected to the remote host 220. After the test program 225 is finished, the remote host 220 receives a test report from the terminal equipment 230, and returns the test report to the server 210.

Before providing the test data 211 to the remote host 220, the server 210 compresses and encrypts the test data 211. Then, the server 210 transmits the encrypted data to the remote host 220 through the communication network. Then, the remote host 220 performs the restoring process on the received encrypted data to retrieve the test data 211. Finally, the remote host 220 performs the test program 225 on the terminal equipment 230 based on the test data 211. Therefore, the test data 211 is prevented from being eavesdropped by a third party when the server 210 transmits the test data 211, thereby guarantee the confidentiality.

What is claimed is:

1. A communication encryption method for supporting a remote monitoring and control system, adapted to transmit a test data between a server and a remote host, the encryption method comprising:
partitioning the test data with an equal capacity based on a length of a first fixed data capacity, so as to produce a plurality of first partitioned data;
performing a compression program on the first partitioned data sequentially, combining the obtained results to produce a compressed data, and storing the compressed data into a first compression buffer;
partitioning the compressed data into a plurality of second partitioned data with a fixed data length, and storing the second partitioned data into an encryption buffer;
performing an encryption program on the second partitioned data to produce a plurality of encrypted data;
transmitting the encrypted data to the remote host, and storing the encrypted data into a decryption buffer;
the remote host performing a decryption program to restore the encrypted data into the second partitioned data;
combining the second partitioned data to restore the data into the compressed data;
performing a decompression program on the compressed data to restore the data into the first partitioned data, and storing the first partitioned data into a second compression buffer;
recombining the first partitioned data to restore the data into the test data; and
based on the test data, the remote host performing a test program to test the terminal equipment.

2. The communication encryption method for supporting a remote monitoring and control system according to claim 1, wherein before transmitting the encrypted data by the server, the method further comprises:
adding a first information and a second information in the encrypted data.

3. The communication encryption method for supporting a remote monitoring and control system according to claim 1, wherein the communication network is a virtual private network (VPN).

4. The communication encryption method for supporting a remote monitoring and control system according to claim 1, wherein the step of restoring the data into the second partitioned data further comprises:
each time when a capacity of the encrypted data reaches a second fixed data capacity, performing the decryption program on the encrypted data to obtain the second partitioned data.

5. The communication encryption method for supporting a remote monitoring and control system according to claim 1, wherein the step of restoring the data into the compressed data further comprises:
when a capacity of the data output by the decompression program reaches the first fixed data capacity, storing the data as the first partitioned data.

6. The communication encryption method for supporting a remote monitoring and control system according to claim 1, wherein after the terminal equipment has tested the test data, the method further comprises:
the remote host further receiving a test report from the terminal equipment and returning the test report to the server.
